(19) United States
(12) Patent Application Publication
(10) Pub. No.: US 2011/0163982 A1
(43) Pub. Date: Jul. 7, 2011

(54) SOLID STATE POSITIVE FORCE TOUCH SENSING

(76) Inventor: Bahar N. Wadia, Bartlett, IL (US)

(21) Appl. No.: 12/940,766

(22) Filed: Nov. 5, 2010

Related U.S. Application Data
(60) Provisional application No. 61/258,378, filed on Nov. 5, 2009.

(51) Int. Cl. G06F 3/041

(52) U.S. Cl. 345/173; 178/18.03

(57) ABSTRACT

A touch sensor pad, including a touch sensor that senses the presence of a touching member placed proximate the touch sensor. A layer of protective material overlies the touch sensor. The layer of protective material has a first surface proximate the touch sensor and an opposing second surface distal from the touch sensor. The second surface includes a resting surface portion and a developed surface portion. The developed surface portion is recessed below the resting surface portion such that the developed surface portion is nearer to the touch sensor than the resting surface portion. The touch sensor has a sensitivity such that the presence of a touching member in contact with the resting surface portion does not result in an actuation of the touch sensor while the presence of a touching member pressed into the developed surface portion does result in the actuation of the touch sensor.

### CLAIM TO PRIORITY

This application claims the benefit of U.S. Provisional Patent Application No. 61/258,378, the entire contents of which is incorporated herein by reference.

### FIELD OF THE INVENTION

The present invention relates to controls, and more specifically to solid-state touch activated control pads.

### BACKGROUND OF THE INVENTION

Touch screens are electronic visual displays that can detect the presence and location of a touch on the surface of the display area. Touching of the display is generally done with a finger or hand. Touch screens operate under a variety of electronic, acoustic or optical principals. Solid-state touch-sensing technologies, like discrete touch pads and multi-touch touch screens have been successfully implemented in a wide variety of products, ranging from cell phones to large display monitors. The success of these technologies in recent years is a direct result of the benefits that these technologies bring to products in which they are used.

A key benefit to using solid-state touch-sensing technologies in discrete touch pads is the virtually infinite life of the touch pads. Unlike mechanical alternatives which have moving components that wear with time in repeated use, a solid state touch sensing screen has no such limitation. Solid state touch sensing screens rarely fail and users worry little about a broken user interface. Touch sensors can be integrated underneath a single solid sealed surface, such as glass or molded plastic, which makes the sensitive components inside the product separated from and largely immune from the outside environment. This is very difficult and costly to achieve with mechanical alternatives. Thus, capacitive touch screen technologies provide great benefits for products that are used in harsh outdoor environments, industrial facilities and other locations that are subject to dirt and moisture.

Another key benefit is achieved in products that require watertight input interfaces. In such products, solid-state touch-sensing can be easily integrated underneath a single solid sealed surface (ex: glass, molded plastic, etc.). Because there are no moving components required to implement solid-state touch-sensing, the single solid sealed surface can deliver both form and function.

The combination of virtually infinite life and watertight implementations can provide tremendous benefit for products that are used in harsh outdoors environment, from gas pumps to outdoor military applications.

Current implementations of solid-state touch-sensing technologies generally require that the finger of a user be in contact with the surface of the discrete touch pad before a touch/actuation is detected. Typically, a sensitivity of the discrete touch pad is adjusted such that an actuation is only detected when the finger comes in contact with the discrete touch pad. If the sensitivity is set too high, there is risk of unintended actuation, as the touch pad may detect an actuation before the user's finger comes in contact with the touch pad, thereby acting like a proximity sensor. If the sensitivity is set too low, there is risk of not detecting an actuation at all.

Hence, a significant drawback for this type of technology is its inability to distinguish between an affirmative touch and an unintended touch. This limitation is further exaggerated in products such as handheld products that use QWERTY keyboards. These products simulate keyboards that people are used to using in a “touch typing” manner. That is, the user tends to rest their fingertips on the surface of the touch pad prior to making an affirmative contact with the touch pad. The resting the user's fingers on the discrete touch pad prior to an affirmative touch almost always results in unintended touch actuations. This then requires the user to delete unintended information or to deal with garbled inputs.

Thus, there is still a need in the industry for an improved solid-state touch sensing control that better distinguishes between intended affirmative contact touches and unintended touches.

### SUMMARY OF THE INVENTION

The present invention addresses the need of the industry through apparatus and methods for distinguishing between an affirmative touch and an unintended touch in the context of discrete touch pad.

Embodiments of the invention include; 1) solid-state touch-sensing technology; and 2) a developed surface over the sensing technology that serves to inhibit the sensing of unintended contact and enable a more definite determination of intended contact. These two elements combined together offer the benefit of implementing solid-state touch-sensing technology in products that lend themselves for a user to rest a finger on the discrete touch pads prior to an affirmative touch without triggering a sensed event.

The solid-state touch-sensing technology can take many forms. One such technology is capacitive sensing technology but other touch-sensing technology may be used with the invention.

The developed surface is formed such that a resting finger over the discrete touch pad does not make sufficiently close contact with the discrete solid-state touch pad to result in a sensing of the finger. To actuate the touch pad, the finger must exert positive pressure over the touch pad. The positive pressure forces the finger into closer contact with the discrete solid-state touch pad, causing the conditions for an affirmative actuation. Furthermore, according to one embodiment of the invention the developed surface includes features to provide tactile feedback to the user when the user provides a positive pressure.

In one example embodiment, the invention includes a touch sensor pad, comprising: a touch sensor that senses the presence of a touching member placed proximate the touch sensor; a layer of protective material overlying the touch sensor, the layer of protective material having a first surface proximate the touch sensor and an opposing second surface distal from the touch sensor; the second surface including a resting surface portion and a developed surface portion, the developed surface portion being recessed below the resting surface portion such that the developed surface portion is nearer to the touch sensor than the resting surface portion; and the touch sensor having a sensitivity such that the presence of a touching member in contact with the resting surface portion does not result in an actuation of the touch sensor while the presence of a touching member pressed into the developed surface portion does result in the actuation of the touch sensor.

In another embodiment of the touch sensor pad, the developed surface portion includes structure that provides tactile feedback when the touching member is a finger and the finger is pressed into the developed surface portion.

In another embodiment of the touch sensor pad, the structure that provides tactile feedback includes a raised portion within the developed surface portion.

In another embodiment of the touch sensor pad, the raised portion presents a dome shaped surface.

In another embodiment the touch sensor pad includes a touch sensor that senses the presence of a touching member placed proximate the touch sensor, the touch sensor having a sensitivity range extending outwardly therefrom wherein a touch from the touching member within the sensitivity range results in an actuation and a touch from the touching member outside the sensitivity range does not result in actuation; a layer of protective material overlying the touch sensor, the layer of protective material having a first surface proximate the touch sensor and an opposing second surface distal from the touch sensor; and the second surface including a resting surface portion and a developed surface portion, the resting surface portion being located outside of the sensitivity range and the developed surface portion being recessed from the resting surface portion and located at least partially within the sensitivity range of the touch sensor.

In another embodiment of the touch sensor pad, the developed surface portion includes structure that provides tactile feedback when the touching member is a finger and the finger is pressed into the developed surface portion.

In another embodiment of the touch sensor pad, the structure that provides tactile feedback comprises a raised portion within the developed surface portion.

In another embodiment of the touch sensor pad, raised portion presents a dome shaped surface.

In another embodiment the invention includes a method of distinguishing between an affirmative touch and an unintended touch in actuation of a touch sensor pad, comprising: presenting a touch sensor pad including a touch sensor that senses the presence of a touching member placed proximate the touch sensor, the touch sensor having a sensitivity range extending outwardly therefrom wherein a touch from the touching member within the sensitivity range results in an actuation and the a touch from the touching member outside the sensitivity range does not result in actuation; covering the touch sensor with a layer of protective material, the layer of protective material having a first surface proximate the touch sensor and an opposing second surface distal from the touch sensor; structuring the second surface to include a resting surface portion and a developed surface portion, the developed surface portion being recessed from the resting surface portion; and adjusting or selecting the touch sensor pad such that the resting surface portion is located outside of the sensitivity range and the developed surface portion is located at least partially within the sensitivity range of the touch sensor.

In another embodiment, the method includes structuring the developed surface portion to include structure that provides tactile feedback when the touching member is a finger and the finger is pressed into the developed surface portion.

In another embodiment, the method further includes shaping the structure that provides tactile feedback to comprise a raised portion within the developed surface portion.

In another embodiment the method includes shaping the raised portion to present a dome shaped surface.

In another embodiment the invention includes a method of using a touch sensor pad, comprising: resting a fingertip on a resting portion of a proximal surface of a layer of protective material overlying a touch sensor and proximal to a developed surface portion of the proximal surface; when it is desired to actuate the touch sensor, pressing the fingertip against the proximal surface of until the fingertip deforms and a deformed portion of the fingertip enters a developed surface portion of the proximal surface thereby placing the portion of the fingertip at least partially within a sensitivity range extending outwardly from the touch sensor wherein the presence of the portion of the fingertip within the sensitivity range results in an actuation; and releasing pressure on the fingertip thereby removing the deformed portion from within the sensitivity range of the touch sensor wherein the absence of the portion of the fingertip within the sensitivity range ends the actuation.

In another embodiment the method includes pressing the deformed portion of the fingertip until it touches a structure within the developed surface that provides tactile feedback and perceiving the tactile feedback prior to the releasing pressure on the fingertip.

### BRIEF DESCRIPTION OF THE DRAWINGS

FIG. 1 depicts a prior art touch pad with the finger of a user in contact with the pad;

FIG. 2 depicts a touch pad according to an embodiment of the invention with the finger of a user in contact with the pad, but wherein the finger is not engaged in the developed surface of the pad so as to cause actuation;

FIG. 3 depicts the pad of FIG. 2 with the finger engaged in the developed surface so as to actuate the control; and

FIG. 4 depicts a touch pad with tactile feedback feature according to another embodiment of the invention with the finger of a user in contact with the pad and engaged in the developed surface so as to actuate the control.

### DETAILED DESCRIPTION

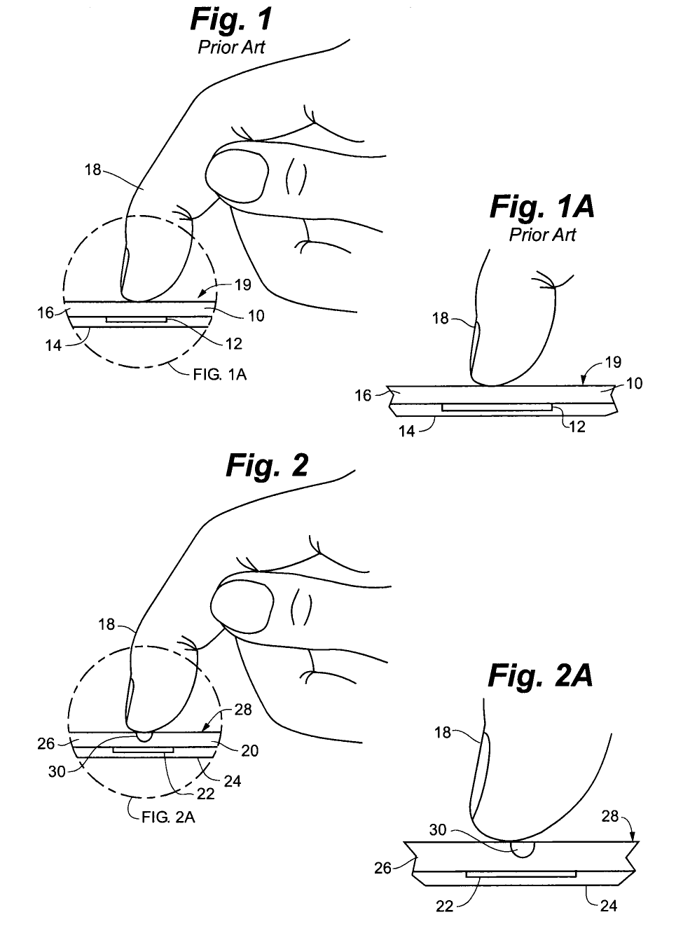

FIG. 1 depicts a prior art capacitive touch sensor pad 10. Capacitive touch pad 10 generally includes capacitive touch sensor 12 which may be mounted on PC board 14 and overlain with a layer of insulative protective material 16. In this example embodiment, when finger 18, other body part or touching member of a user is placed in sufficient proximity with sensor 12, a capacitive signal is generated by sensor 12 to indicate a control actuation. A drawback of this prior art system is that it is difficult or impossible to adjust the sensitivity of the system to enable a user to place a finger on pad surface 19, as may be sometimes desirable to, for example, permit “touch typing” operation, without causing actuation. Thus, in the prior art resting the fingers on insulative protective material 16 overlying capacitive touch sensor 12 nearly always results in an unintended control actuation.

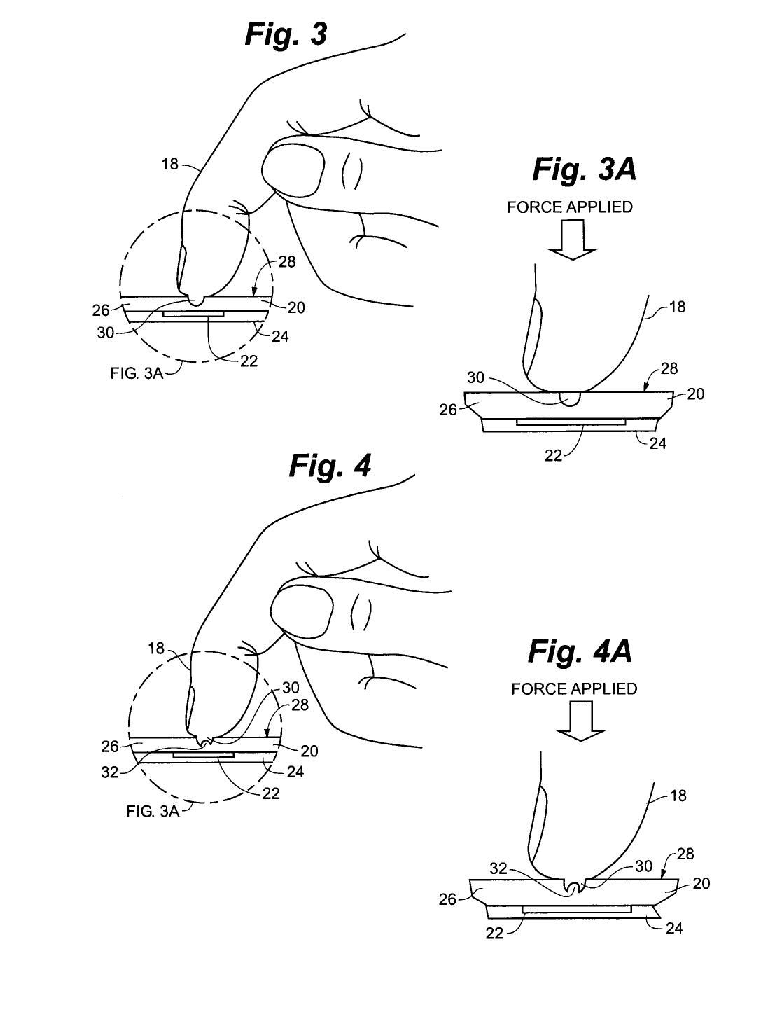

FIGS. 2 and 3 depict touch sensor pad 20 according to an example embodiment of the invention, generally includes capacitive touch sensor 22 which may be mounted on PC board 24, overlain with a layer of insulative protective material 26. Surface 28 of protective material 26 defines recess 30 over touch sensor 22. As depicted in FIG. 2, finger 18 may be rested on surface 28 but not engaged in recess 30. When more pressure is applied to finger 18, however, a portion of finger 18 is deformed by the pressure and engages in recess 30 as depicted in FIG. 3, thereby enabling closer proximity of finger 18 to the sensor 22.

It will be appreciated that control signal receiving electronics (not shown) may be adjusted so that the control signal magnitude generated by the closer approach of finger 18 when engaged in recess 30 as depicted in FIG. 3 causes an actuation, while the control signal magnitude generated by the more distant proximity of finger 18 simply resting on surface 28 of protective material 26 as depicted in FIG. 2 does not. Hence, a user may rest finger 18 on touch sensor pad 20 without unintentionally causing actuation. Further, an expected benefit of the invention is that unintended control actuation by accidental contact with touch sensor pad 20 may be greatly reduced or eliminated.

In other embodiments, surface 28 may define structures providing tactile feedback to the user when pressure is sufficient to cause actuation so that the user is able to perceive when control actuation occurs by sense of touch. For example, as depicted in FIG. 4, a raised portion 32 may be provided in recess 30 so that the user can more easily feel when sufficient pressure is being exerted to cause actuation. In another, embodiment, sensory feedback may be supplied by auditory or visual feedback. For example, a positive actuation may be accompanied by a “click” sound or by a visual feedback such as illumination or color change of the touch sensor pad 20.

Accordingly, embodiments of the invention may offer certain advantages over prior art touch sensing devices. For example, discrete solid-state touch-sensing technologies may be deployed in applications in which people tend to rest their fingers on the discrete touch pad prior to an affirmative touch with a reduction in unintended sensing of the resting fingers. Another benefit of the invention is that sealed discrete solid-state touch-sensing solutions may be deployed in harsh outdoor environments, dirty environments and environments where they may be subject to moisture. Solid-state tactile feedback is a very important component for good human factors and inherently missing in prior solid-state touch-sensing technologies.

The present invention may be embodied in other specific form without departing from the spirit of the essential attributes thereof, therefore, the illustrated embodiment should be considered in all respect as illustrative and not restrictive, reference being made to the appended claims rather than to the foregoing description to indicate the scope of the invention.

What is claimed is:

1. A touch sensor pad, comprising:
a touch sensor that senses the presence of a touching member placed proximate the touch sensor;
a layer of protective material overlying the touch sensor, the layer of protective material having a first surface proximate the touch sensor and an opposing second surface distal from the touch sensor;
the second surface including a resting surface portion and a developed surface portion, the developed surface portion being recessed below the resting surface portion such that the developed surface portion is nearer to the touch sensor than the resting surface portion; and
the touch sensor having a sensitivity such that the presence of a touching member in contact with the resting surface portion does not result in an actuation of the touch sensor while the presence of a touching member pressed into the developed surface portion does result in the actuation of the touch sensor.

2. The touch sensor pad as claimed in claim 1, wherein the developed surface portion includes structure that provides tactile feedback when the touching member is a finger and the finger is pressed into the developed surface portion.

3. The touch sensor pad as claimed in claim 2, wherein the structure that provides tactile feedback comprises a raised portion within the developed surface portion.

4. The touch sensor pad as claimed in claim 3, wherein the raised portion presents a dome shaped surface.

5. A touch sensor pad, comprising:
a touch sensor that senses the presence of a touching member placed proximate the touch sensor, the touch sensor having a sensitivity range extending outwardly therefrom wherein a touch from the touching member within the sensitivity range results in an actuation and a touch from the touching member outside the sensitivity range does not result in actuation;
a layer of protective material overlying the touch sensor, the layer of protective material having a first surface proximate the touch sensor and an opposing second surface distal from the touch sensor; and
the second surface including a resting surface portion and a developed surface portion, the resting surface portion being located outside of the sensitivity range and the developed surface portion being recessed from the resting surface portion and located at least partially within the sensitivity range of the touch sensor.

6. The touch sensor pad as claimed in claim 5, wherein the developed surface portion includes structure that provides tactile feedback when the touching member is a finger and the finger is pressed into the developed surface portion.

7. The touch sensor pad as claimed in claim 6, wherein the structure that provides tactile feedback comprises a raised portion within the developed surface portion.

8. The touch sensor pad as claimed in claim 7, wherein the raised portion presents a dome shaped surface.

9. A method of distinguishing between an affirmative touch and an unintended touch in actuation of a touch sensor pad, comprising:
presenting a touch sensor pad including a touch sensor that senses the presence of a touching member placed proximate the touch sensor, the touch sensor having a sensitivity range extending outwardly therefrom wherein a touch from the touching member within the sensitivity range results in an actuation and the a touch from the touching member outside the sensitivity range does not result in actuation;
covering the touch sensor with a layer of protective material, the layer of protective material having a first surface proximate the touch sensor and an opposing second surface distal from the touch sensor;
structuring the second surface to include a resting surface portion and a developed surface portion, the developed surface portion being recessed from the resting surface portion; and
adjusting or selecting the touch sensor pad such that the resting surface portion is located outside of the sensitivity range and the developed surface portion is located at least partially within the sensitivity range of the touch sensor.

10. The method as claimed in claim 9 further comprising structuring the developed surface portion to include structure that provides tactile feedback when the touching member is a finger and the finger is pressed into the developed surface portion.

11. The method as claimed in claim 10, further comprising shaping the structure that provides tactile feedback to comprise a raised portion within the developed surface portion.

12. The method as claimed in claim 11, further comprising shaping the raised portion to present a dome shaped surface.

13. A method of using a touch sensor pad, comprising:
resting a fingertip on a resting portion of a proximal surface of a layer of protective material overlying a touch sensor and proximal to a developed surface portion of the proximal surface,
when it is desired to actuate the touch sensor, pressing the fingertip against the proximal surface of until the fingertip deforms and a deformed portion of the fingertip enters a developed surface portion of the proximal surface thereby placing the portion of the fingertip at least partially within a sensitivity range extending outwardly from the touch sensor wherein the presence of the portion of the fingertip within the sensitivity range results in an actuation; and
releasing pressure on the fingertip thereby removing the deformed portion from within the sensitivity range of the touch sensor wherein the absence of the portion of the fingertip within the sensitivity range ends the actuation.

14. The method as claimed in claim 13 further comprising pressing the deformed portion of the fingertip until it touches a structure within the developed surface that provides tactile feedback and perceiving the tactile feedback prior to the releasing pressure on the fingertip.
